(19) United States
(12) Patent Application Publication
(10) Pub. No.: US 2016/0292160 A1
(43) Pub. Date: Oct. 6, 2016

(54) PERSONALIZED CONTENT-BASED TRAVEL PLAN SUPPORT SYSTEM

(71) Applicant: FUJITSU LIMITED, Kawasaki-shi (JP)

(72) Inventor: Naomi HADATSUKI, San Jose, CA (US)

(21) Appl. No.: 14/675,508

(22) Filed: Mar. 31, 2015

(51) Int. Cl. G06F 17/30; H04L 29/08; H04L 12/24

(52) U.S. Cl. CPC G06F 17/3053; H04L 41/22; H04L 67/18; G06F 17/30554

(57) ABSTRACT

A method to build a personalized content-based travel plan includes receiving input indicating one or more content sources to analyze for potential places to visit and accessing the content sources from a non-transitory computer medium and analyzing them for potential places to visit with. The method also includes identifying content attributes for each potential places to visit and tagging the content attributes to their respective potential place to visit. The method further includes determining whether each potential place to visit has a physical location with coordinates, assigning a weight value to each content attribute, summing up all of the weighted content attributes for each potential place to visit, generating a content attribute score, prioritizing each potential place to visit based on their content attribute scores, and providing a prioritized list of potential places to visit to a user.

### FIELD

The embodiments discussed herein are related to a personalized content-based travel plan support system.

### BACKGROUND

Unless otherwise indicated herein, the materials described in this section are not prior art to the claims in the present application and are not admitted to be prior art by inclusion in this section.

In recent years, travelers are becoming more interested in theme-oriented traveling. Themes may be based on many different types of content sources, (e.g., books, movies, publications, etc.), which may contain plots, stories, events, scenes, and sites that are associated with real world locations that travelers may desire to visit. Travelers interested in particular content sources may desire to create travel plans based on those content sources. These travelers may also want to personalize their content-based travel plans to best fit their particular circumstances.

The subject matter claimed herein is not limited to embodiments that solve any disadvantages or that operate only in environments such as those described above. Rather, this Background Section is provided to illustrate one exemplary technology area where embodiments of the present disclosure described herein may be practiced.

### SUMMARY

According to an aspect of an implementation, a computer implemented method to build a personalized content-based travel plan includes receiving input effective to indicate one or more content sources to analyze for potential places to visit. The method also includes accessing the content sources from a non-transitory computer medium and analyzing the content sources for potential places to visit. The method includes identifying at least one content attribute for each of the potential places to visit and tagging the content attribute to the potential place to visit. The method further includes determining whether each potential place to visit has a physical location with coordinates and tagging the coordinates to their respective potential place to visit. The method additionally includes assigning a weight value to each content attribute, summing up all of the weighted content attributes for each potential place to visit to create a content attribute score, prioritizing each potential place to visit with respect to each other based on their respective content attribute scores, and providing a prioritized list of potential places to visit to a user.

The object and advantages of the implementations will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example implementations will be described and explained with additional specificity and detail through the use of the accompanying drawings in which:

FIG. 1 is a block diagram of an example operating environment in which some implementations may be implemented;

FIG. 2 is a block diagram illustrating an example travel plan support system to build a personalized content-based travel plan;

FIG. 3 is a block diagram illustrating an example personal travel plan profile that may be included in the system of FIG. 2;

FIG. 4 shows an example flow diagram of a method to build a personalized content-based travel plan;

FIG. 5 shows an example flow diagram of a method to extract potential places to visit from the content sources of FIG. 4;

FIG. 6A shows an example flow diagram of a method to extract content attributes for the potential places to visit of FIG. 5;

FIG. 6B shows an example flow diagram of a method to determine location coordinates for the potential places to visit of FIG. 5;

FIG. 7A shows an example flow diagram of a method to classify the potential places to visit of FIG. 5 based on their content attribute scores;

FIG. 7B shows an example flow diagram of a method to identify travel attributes for the potential places to visit of FIG. 5;

FIG. 8A shows an example flow diagram of a method to classify the potential places to visit of FIG. 5 based on their combined attribute scores; and

FIG. 8B shows an example flow diagram of a method to classify the content sources of FIG. 5 based on their content source scores.

### DESCRIPTION OF IMPLEMENTATIONS

This disclosure is generally drawn, inter alia, to methods, apparatus, systems, devices, and computer program products that generally relate to creating personalized content-based travel plans. For example, a traveler may desire to create travel plans based on a content source, such as an ebook, which includes potential places to visit.

As an example, the system described herein may extract potential places to visit from a content source and determine whether the potential places to visit have a real physical location with coordinates. The system may also help the traveler quickly decide which potential places he or she would like to visit by prioritizing the potential places to visit based on their content and/or travel attributes and then presenting the most prominent and interesting potential places to visit to the traveler for his or her consideration before presenting the less prominent and interesting potential places to visit to the traveler.

The system may display potential places to visit to the traveler on a map and receive inputs from the traveler, such as selecting potential places to visit, the order of visiting each potential place to visit, and transportation options between the selected potential places to visit. The system may create a travel plan itinerary showing the selected potential places to visit, the order of visiting each selected potential place to visit, transportation options between each selected potential place to visit, and other useful information described herein.

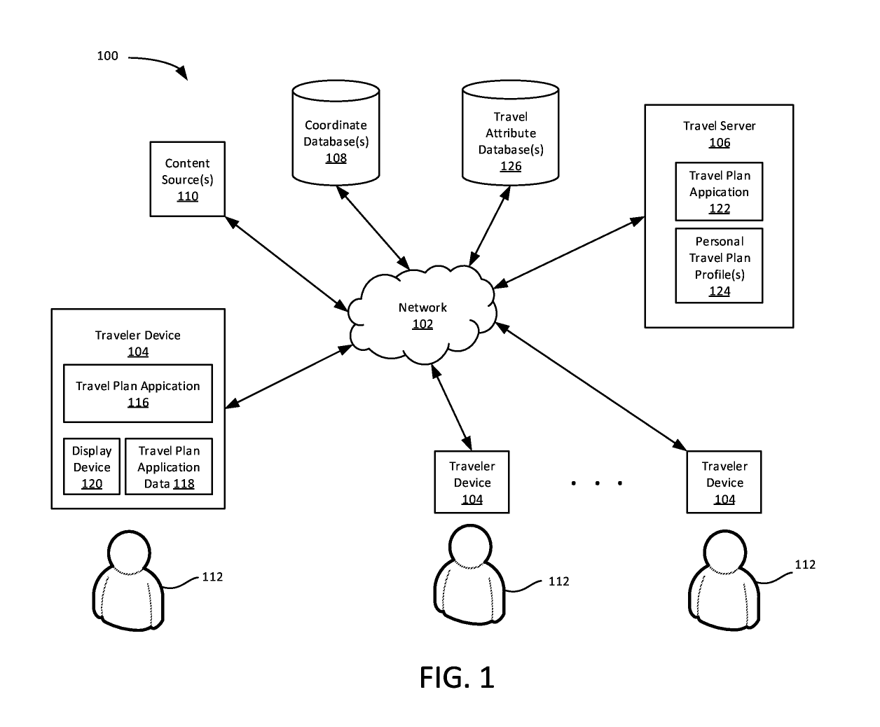

FIG. 1 is a block diagram of an example operating environment 100 in which some implementations may be implemented. The operating environment 100 may include a network 102, one or more traveler devices (hereinafter “traveler device” or “traveler devices”) 104, a travel server 106, one or more coordinate databases (hereinafter “coordinate database” or “coordinate databases”) 108, one or more travel attribute databases (hereinafter “travel attribute database” or “travel attribute databases”) 126, one or more content sources 110 (hereinafter “content source” or “content sources”), and one or more travelers (hereinafter “traveler” or “travelers” or “user” or “users”) 112.

In general, the network 102 may include one or more wide area networks (WANs) and/or local area networks (LANs) that enable the traveler devices 104 and the travel server 106 to access the content sources 110 and/or that enable one or more of the traveler devices 104, the travel server 106, the coordinate database 108, and/or the travel attribute database 126 to communicate with each other. In some implementations, the network 102 includes the Internet, including a global internetwork formed by logical and physical connections between multiple WANs and/or LANs. Alternately or additionally, the network 102 may include one or more cellular RF networks and/or one or more wired and/or wireless networks such as, but not limited to, 802.xx networks, Bluetooth access points, wireless access points, IP-based networks, or the like. The network 102 may also include servers that enable one type of network to interface with another type of network.

The content sources 110 may include any media that has at least some textual content, or from which textual content may be extracted, including but not limited to: books, ebooks, books on tape, pod casts, articles, magazines, newspapers, pamphlets, movies, movie transcripts, motion pictures, closed captioning, subtitles, TV programs, musicals, plays, video games, radio broadcasts, web pages, blogs, RSS feeds, PDF documents, scrap books, diaries, social media websites, search histories, etc. The content sources 110 may be hosted at one or more web servers (not shown) accessible to the traveler devices 104 via the network 102 or other suitable location. Alternately or additionally, the content sources 110 may be accessed locally on the traveler devices 104, may be exchanged via device-to-device communication between one of the traveler devices 104 and another of the devices or servers of FIG. 1, and/or may be exchanged via thumb drive or other computer storage medium.

Each of the traveler devices 104 may include a desktop computer, a laptop computer, a tablet computer, a mobile phone, a smartphone, a personal digital assistant (PDA), an e-reader device, or other suitable computer device. The traveler devices 104 may generally be configured to access and display content sources 110 to the travelers 112. Each traveler device 104 may include a travel plan application 116, travel plan application data 118, and an output device, such as a display device 120. For simplicity, the travel plan application 116, travel plan application data 118, and display device 120 are illustrated in FIG. 1 for a single one of the traveler devices 104, and each of the other traveler devices 104 may similarly include one or more of the foregoing components. Additionally, each traveler device 104 may include other components not shown, such as a processor device, memory, input and output devices, and a communication interface.

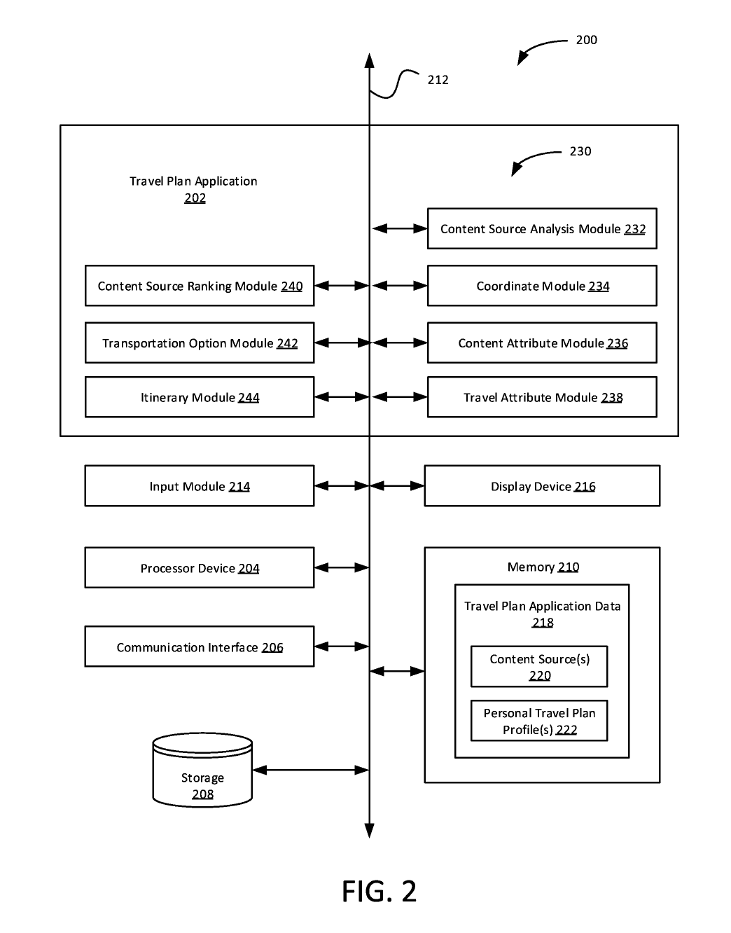

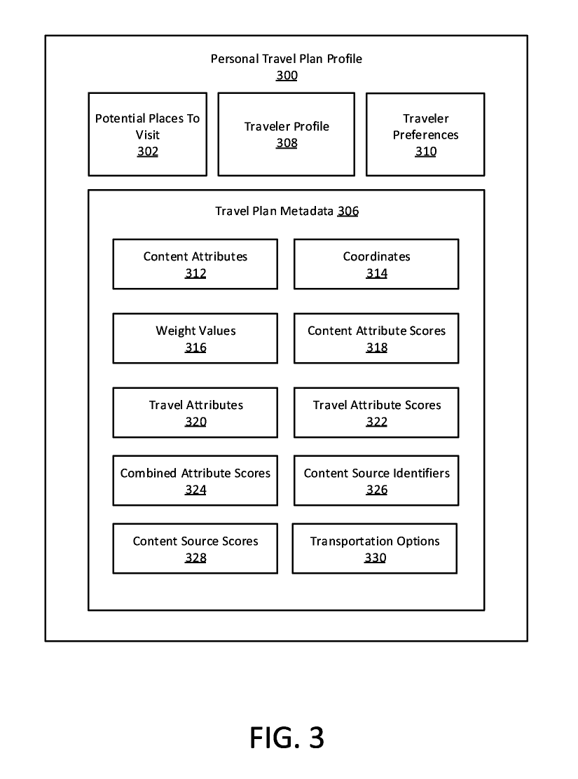

The travel plan application 116 may generally be configured to help a corresponding one of the travelers 112 build a personalized content-based travel plan. In some implementations, the traveler 112 may interact with the travel plan application 116 through a graphical user interface (GUI), which may be output to the display device 120. The traveler 112 may submit various choices and selections as input into the travel plan application 116 through the graphical user interface, including but not limited to: selections relating to one or more of the content sources 110 to analyze for potential places to visit, manually entered data such as a manually entered potential place to visit which did not appear in the content sources, desired geographic area(s) to visit, desired time frame(s) for visiting, selecting places to visit, selecting the order for visiting each place, selecting a method of transportation between each place to visit, etc. The travel plan application 116 will be discussed in more detail below with reference to FIGS. 2 and 3.

The travel plan application data 118 may include data used by the travel plan application 116. For instance, the travel plan application data 118 may include one or more content sources 110, a personal travel plan profile of the traveler 112, travel plan metadata, travel map data, travel plan itinerary data, or components thereof that are at least temporarily stored on or otherwise accessible to the traveler device 104. The travel plan application data 118 will be discussed in more detail with respect to FIGS. 2 and 3.

The display device 120 may generally be configured to display the content sources 110 and travel plan application data 118. The display device 120 may include a built-in monitor of the traveler device 104 implemented as a laptop computer, a tablet computer, a mobile phone, a smartphone, a PDA, an e-reader device, or other traveler device with a built-in monitor. Alternately or additionally, the display device 120 may be implemented as an external monitor, a projector, a television, or other suitable display device 120 that may be separate from and communicatively coupled to the traveler device 104.

The travel server 106 may host a travel plan application 122 and/or one or more personal travel plan profiles (hereinafter “personal travel plan profile” or “personal travel plan profiles”) 124. The travel plan application 122 may provide a server-based version of the travel plan application 116, e.g., for use in a client-server relationship between the travel server 106 and the traveler devices 104. In some implementations, the travel plan application 116 of the traveler device 104 may generally include client-side components associated with creating personalized content-based travel plans while the travel plan application 122 of the travel server 106 may generally include server-side components associated with creating personalized content-based travel plans.

In some implementations, one or both of the travel plan applications 116, 122 may be implemented using hardware including a field-programmable gate array (FPGA) or an application-specific integrated circuit (ASIC). In some other implementations, one or both of the travel plan applications 116, 122 may be implemented using a combination of hardware and software. The travel plan applications 116, 122 may be stored in a combination of the devices and servers, or in one of the devices or servers of FIG. 1. An example implementation of a travel plan application that may correspond to one or both of the travel plan applications 116, 122 is described below in more detail.

Each of the personal travel plan profiles 124 may be associated with a different one of the travelers 112. An example personal travel plan profile that may correspond to the personal travel plan profiles 124 is described in more detail with respect to FIG. 3.

Each of the coordinate databases 108 may include one or more coordinates or other geographic location data that identifies the location of one or more potential places to visit. The coordinate databases 108 may be obtained from or based on any website that contains coordinate or geographic location data for potential places to visit, such as Google Maps® and Wikipedia®, or from other suitable sources. As will be described in more detail with respect to, e.g., FIGS. 2 and 3, the coordinate databases 108 may be used to determine whether a potential place to visit has an actual physical location with coordinates or other geographic location data.

Each of the travel attribute databases 126 may include one or more travel attributes or useful information about each potential place to visit. Travel attributes may help a traveler 112 learn about a particular potential place to visit so the traveler 112 may decide if he or she would like to include the potential place to visit to his or her travel plans. Travel attributes may include, but are not limited to: ratings, hours of operation, suggested duration for a visit, price, descriptions, helpful tips, etc., which are related to a potential place to visit. The travel attribute databases 126 may be obtained from or based on any website that contains travel attribute information or any other useful information related to potential places to visit, such as travel websites, blogs, or other suitable sources. The travel attribute databases 126 will be described in more detail with respect to, e.g., FIGS. 2 and 3.

FIG. 2 is a block diagram illustrating an example travel plan support system (hereinafter “system”) 200 to build a personalized content-based travel plan, arranged in accordance with at least one implementation described herein. The system 200 may include or correspond to either or both of the traveler devices 104 and the travel server 106 of FIG. 1. The system 200 may be implemented as a computing device having any suitable form factor, such as a desktop computer, a laptop computer, a tablet computer, a mobile phone, a smartphone, a personal digital assistant (PDA), an e-reader device, a rack-mounted server computer, a blade server computer, or other suitable computing device.

The system 200 may include a travel plan application 202, a processor device 204, a communication interface 206, a storage 208, and a memory 210 according to some examples. The components of the system 200 may be communicatively coupled by a bus 212. The bus 212 may include, but is not limited to, a memory bus, a storage interface bus, a bus/interface controller, an interface bus, or the like or any combination thereof. In some implementations, the system 200 additionally includes a display device 216 and an input module 214, each coupled to the bus 212.

The input module 214 may be configured to receive input from a traveler 112. The input may then be utilized by the travel plan application 202, or by any other component of system 200. Some implementations of the input module 214 include an interactive GUI that is displayed on the display device 216 and is configured to receive input from the traveler 112. The input module 214 may alternately or additionally include or be communicatively coupled to one or more input devices, such as a touchscreen, a typewriter, a mouse, a microphone, or other suitable input device.

The processor device 204 includes an arithmetic logic unit, a microprocessor, a general-purpose controller, or some other processor array to perform or control performance of operations as described herein. The processor device 204 processes data signals and may include various computing architectures including a complex instruction set computer (CISC) architecture, a reduced instruction set computer (RISC) architecture, or an architecture implementing a combination of instruction sets. Although FIG. 2 includes a single processor device 204, multiple processor devices may be included. Other processors, operating systems, and physical configurations may be possible.

The communication interface 206 may be configured to transmit and receive data to and from at least one of the traveler device 104, the travel server 106, the coordinate database 108, the travel attribute database 126, and any other entities of the operating environment 100 of FIG. 1. In some implementations, the communication interface 206 includes a port for direct physical connection to the network 102 of FIG. 1 or to another communication channel. For example, the communication interface 206 may include a universal serial bus (USB) port, a secure digital (SD) port, a category 5 cable (CAT-5) port, or similar port for wired communication with the traveler device 104, the travel server 106, the coordinate database 108, the travel attribute database 126, or any other entities of FIG. 1. In some implementations, the communication interface 206 includes a wireless transceiver for exchanging data with at least one of the traveler device 104, the travel server 106, the coordinate database 108, the travel attribute database 126, or any other entities of FIG. 1 or other communication channels using one or more wireless communication methods, including IEEE 802.11, IEEE 802.16, BLUETOOTH®, WiFi, Zigbee, NFC, or another suitable wireless communication method.

In some implementations, the communication interface 206 includes a cellular communications transceiver for sending and receiving data over a cellular communications network including via short messaging service (SMS), multimedia messaging service (MMS), hypertext transfer protocol (HTTP), direct data connection, wireless application protocol (WAP), e-mail, or another suitable type of electronic communication. In some implementations, the communication interface 206 includes a wired port and a wireless transceiver. The communication interface 206 may also provide other connections to the network 102 of FIG. 1 for distribution of files or media objects using standard network protocols including transmission control protocol/internet protocol (TCP/IP), HTTP, HTTP secure (HTTPS), and simple mail transfer protocol (SMTP), etc.

The storage 208 may include a non-transitory storage medium that stores data for providing the functionality described herein. The storage 208 may include a dynamic random access memory (DRAM) device, a static random access memory (SRAM) device, flash memory, or some other memory devices. In some implementations, the storage 208 also includes a non-volatile memory or similar permanent storage and media including a hard disk drive, a floppy disk drive, a CD-ROM device, a DVD-ROM device, a DVD-RAM device, a DVD-RW device, a flash memory device, or some other mass storage for storing information on a more permanent basis. The storage 208 may also store instructions and/or data that are temporarily stored or loaded into the memory 210.

The memory 210 stores instructions or data that may be executed or operated on by the processor device 204. The instructions or data may include programming code that may be executed by the processor device 204 to perform or control performance of the operations described herein. The memory 210 may include a dynamic random access memory (DRAM) device, a static random access memory (SRAM) device, flash memory, or some other memory device. In some implementations, the memory 210 also includes a non-volatile memory or similar permanent storage and media including a hard disk drive, a floppy disk drive, a CD-ROM device, a DVD-ROM device, a DVD-RAM device, a DVD-RW device, a flash memory device, or some other mass storage for storing information on a more permanent basis.

The memory 210 may store travel plan application data 218. The travel plan application data 218 may include one or more content sources (hereinafter “content source” or “content sources”) 220 and one or more personal travel plan profiles (hereinafter “personal travel plan profile” or “personal travel plan profiles”) 222. The travel plan application data 218 may correspond to the travel plan application data 118 of FIG. 1. Alternately or additionally, the content sources 220 may correspond to the content sources 110 and/or the personal travel plan profiles 222 may correspond to the personal travel plan profiles 124 of FIG. 1.

FIG. 3 is a block diagram illustrating an example personal travel plan profile 300, arranged in accordance with at least one implementation described herein. The personal travel plan profile 300 may be an example of the personal travel plan profiles 124 and 222 of FIGS. 1 and 2 and may be associated with a particular one of the travelers 112. As illustrated in FIG. 3, the personal travel plan profile 300 may include one or more potential places to visit (hereinafter “potential place to visit” or “potential places to visit”) 302. Alternately or additionally, the personal travel plan profile 300 may include travel plan metadata 306, a traveler profile 308, and/or traveler preferences 310.

The potential places to visit 302 may be extracted from one or more content sources 110, 220 selected by the traveler 112. For example, if the traveler 112 enjoys a particular ebook which includes one or more potential places to visit 302, the traveler 112 may select the ebook for analysis and the one or more potential places to visit 302 included in the ebook may be extracted. The traveler 112 may then use the extracted potential places 302 to visit to create a travel plan based on the ebook, as will be explained in greater detail below.

The traveler profile 308 may include data that, at least in aggregate, uniquely identifies the traveler 112. For example, the traveler profile 308 may include one or more of a name, a username, an address, an e-mail address, a mobile phone number, a date of birth, or other information of the traveler. The traveler profile 308 may include data that identifies all of the content sources that are associated with the traveler. For example, the traveler profile 308 may include identification data for all of the ebooks purchased or read by the traveler. Likewise, the traveler profile 308 may include identification data for all of the content sources associated with the traveler including, but not limited to: books, ebooks, books on tape, pod casts, articles, magazines, newspapers, pamphlets, movies, movie transcripts, motion pictures, closed captioning, subtitles, TV programs, musicals, plays, video games, radio broadcasts, web pages, blogs, RSS feeds, PDF documents, scrap books, diaries, social media websites, search histories, etc.

The traveler preferences 310 may include one or more preferences of the traveler 112 with respect to building travel plans. For example, the traveler preferences 310 may indicate one or more topics of interest to the traveler to help the traveler identify all content sources that relate to a particular topic of interest, geographic areas of interest to the traveler, preferred travel times (e.g., particular seasons, months, weeks, days of the week, time of day), preferred transportation modes and carriers, preferred accommodation types and providers, preferred food types and restaurants, etc. The traveler preferences 310 may also include data or settings to indicate one or more preferred subsets of content sources to search for potential places to visit 302 when the traveler knows the geographic location(s) that the traveler will be visiting, but the traveler may not know which content source(s) have potential places to visit 302 with coordinates pertaining to those geographic location(s). For example, the traveler preferences 310 may include data or settings to indicate that the travel plan application 202 is to search only a subset of the content sources associated with the traveler, such as the traveler's ebooks, if the traveler wishes to search for potential places to visit 302 via geographic location. Likewise, any other subset of content sources or combination of content sources may be indicated in the traveler preferences 310. Additionally, the traveler may indicate that he or she prefers that all content sources be searched for potential places to visit 302 when the traveler performs searches via geographic location.

The travel plan metadata 306 may include one or more of content attributes 312, coordinates 314, weight values 316, content attribute scores 318, travel attributes 320, travel attribute scores 322, combined attribute scores 324, content source identifiers 326, content source scores 328, and transportation options 330.

The content attributes 312 may include one or more content attributes 312 for each of the potential places to visit 302. The content attributes 312 may generally indicate which potential places to visit 302 are prominent in a selected content source. The content attributes 312 may also generally indicate which potential places to visit 302 the traveler 112 has identified, or otherwise expressed some interest in. For example, if the selected content source is an ebook, then content attributes 312 related to potential places to visit 302 contained in the ebook may include, but are not limited to: the number of times a potential place to visit 302 appears in the ebook, whether the traveler highlighted a potential place to visit 302 in the ebook (and/or how many times), whether the traveler annotated a potential place to visit 302 in the ebook (and/or how many times), whether the traveler performed a search for a potential place to visit 302 (e.g., dictionary search, Wikipedia® search, a video search, an image search, a web search, etc., and/or how many times the user performed the search for the potential place to visit 302), and whether the traveler shared or otherwise discussed a potential place to visit 302 (e.g., via email, Facebook®, Twitter®, SMS text message, blog, etc., and/or how many times the user shared or discussed the potential place to visit 302). In this manner, the content attributes 312 may be used to help prioritize the potential places to visit 302 which are found in a content source. For example, the most prominent or potentially interesting potential places to visit 302 may be presented to the traveler for consideration before less prominent or less interesting potential places to visit 302, as will be discussed in more detail below.

The coordinates 314 may include different coordinates or other geographic location data for each of the potential places to visit 302. The coordinates 314 may generally indicate the actual physical location for each potential place to visit 302 or other geographic location information that may be helpful in guiding a traveler to a potential place to visit 302.

The weight values 316 may include different weight values for each content attribute 312 and/or travel attribute 320 that is associated with a potential place to visit 302. The weight values 316 may be used to differentiate content attributes 312 and/or travel attributes 320 from each other to indicate the level of importance or potential interest for each content attribute 312 and/or travel attribute 320. For example, it may be determined that a potential place to visit 302 that is highlighted in a content source is to be given greater weight than a potential place to visit 302 that merely appears in the content source. Accordingly, a higher weight value 316 may be applied to a potential place to visit 302 that is highlighted in a content source than to one that merely appears in the content source. In another example, it may be determined that travel attributes 320 for a potential place to visit 302, such as ratings or reviews, are to be given greater weight than travel attributes 320 such as a suggested duration for visiting a potential place to visit 302. Accordingly, a higher weight value 316 may be applied to ratings or reviews for a potential place to visit 302 than for a suggested duration for visiting the potential place to visit 302. In some implementations, the weight values 316 may be numbers which are assigned to, or multiplied with, each of the content attributes 312 and/or travel attributes 320. The weight values 316 for each of the different types of content attributes 312 and travel attributes 320 may be preselected or pre-assigned by a developer of the travel plan application 116, 122, 202. Alternatively, or in addition thereto, the weight values 316 may be selected or assigned by a system manager of the travel plan applications 116, 122, 202, or by the traveler 112.

The content attribute scores 318 may include different content attribute scores 318 for each potential place to visit 302. The content attribute scores 318 may be used to prioritize the potential places to visit 302 according to their respective content attribute scores 318. The content attribute score 318 for a potential place to visit 302 may be calculated by summing up all of the weighted content attributes 312 associated with a potential place to visit 302 to generate a content attribute score 318 for the potential place to visit 302. After all of the content attribute scores 318 have been calculated, each potential place to visit 302 may be prioritized with respect to each other based on their respective content attribute scores 318. This information may be used to help the traveler create a travel plan in a more efficient manner. For example, the most prominent or potentially interesting potential places to visit 302 may be presented to the traveler for consideration before less prominent or less interesting potential places to visit 302.

The travel attributes 320 may include one or more travel attributes 320 for each of the potential places to visit 302. The travel attributes 320 may include useful information about a potential place to visit 302 that may help the traveler 112 learn about the particular potential place to visit 302 and/or decide whether he or she would like to add the potential place to visit 302 to his or her travel plans. The travel attributes 320 may include, but are not limited to: ratings, hours of operation, suggested duration for a visit, price, descriptions, helpful tips, etc., which are related to a potential place to visit 302.

The travel attribute scores 322 may include different travel attribute scores 322 for each potential place to visit 302. The travel attribute scores 322 may be used to prioritize the potential places to visit 302 according to their respective travel attribute scores 322. The travel attribute score 322 for a potential place to visit 302 may be calculated by summing up all of the weighted travel attributes 320 associated with a potential place to visit 302 to generate a travel attribute score 322 for the potential place to visit 302. After all of the travel attribute scores 322 have been calculated for each potential place to visit 302, the potential places to visit 302 may be prioritized with respect to each other based on their respective travel attribute scores 322. This information may be used to help the traveler create a travel plan in a more efficient manner. For example, the potential places to visit 302 with higher travel attribute scores 322 may be presented to the traveler for consideration before potential places to visit 302 with lower travel attribute scores 322.

The combined attribute scores 324 may include different combined attribute scores for each potential place to visit 302. The combined attribute scores 324 may be used to prioritize the potential places to visit 302 according to their respective combined attribute scores 324. The combined attribute score 324 for a potential place to visit 302 may be calculated by combining the content attribute score 318 with the travel attribute score 322 for the potential place to visit 302. The content attribute scores 318 may be combined with the travel attribute scores 322 through simple addition. Alternatively, or in addition thereto, the content attribute scores 318 and the travel attribute scores 322 may be differently weighted with respect to each other and then added together to generate a combined attribute score 324. After all of the combined attribute scores 324 have been calculated for each potential place to visit 302, the potential places to visit 302 may be prioritized with respect to each other based on their respective combined attribute scores 324. This information may be used to help the traveler create a travel plan in a more efficient manner. For example, the potential places to visit 302 with higher combined attribute scores 324 may be presented to the traveler for consideration before potential places to visit 302 with lower combined attribute scores 324.

The content source identifiers 326 may include different content source identifiers for each potential place to visit 302. A content source identifier 326 that is associated with a potential place to visit 302 may generally indicate the content source 110, 220 in which the potential place to visit 302 was located. The content source identifiers 326 may be used to classify and/or prioritize multiple content sources with respect to each other to help the traveler 112 further narrow down the number of content sources for selection, as will be discussed below with respect to the content source scores 328.

The content source scores 328 may include different content source scores for each content source that is selected by the traveler 112. The content source scores 328 may be used to prioritize each of the selected content sources according to their respective content source scores 328. The content source score 328 for a content source may be calculated by summing up all of the combined attribute scores 324 for each of the potential places to visit 302 that has the same content source identifier 326 to generate a content source score 328 for the content source. After all of the content source scores 328 have been calculated for each content source, the content sources may be prioritized with respect to each other based on their respective content source scores 328. This information may be used to help the traveler further narrow down his or her content source selection. For example, the content sources with higher content source scores 328 may be presented to the traveler for consideration before the content sources with lower content source scores 328.

The transportation options 330 may include different transportation options that may be available to the traveler 112 between different potential places to visit 302. Example transportation options may include, but are not limited to: car, taxi, bus, subway, train, trolley, cable car, walking, bike, motorcycle, scooter, Segway® scooter, rickshaw, airplane, jet, helicopter, snow machine, boat, tramway, gondola, etc. Additionally, each transportation option 330 may include appropriate data associated with the transportation option 330 such as price, arrival and departure times, schedules, pick-up and drop-off locations, estimated travel times between each potential place to visit 302, and the like. The transportation options 330 may be obtained from one or more transportation option databases (not shown), or from any website that contains transportation option information between potential places to visit 302 such as Google Maps®, or from any other suitable source.

Returning to FIG. 2, the travel plan application 202 may include at least one of: a content source analysis module 232, a coordinate module 234, a content attribute module 236, a travel attribute module 238, a content source ranking module 240, a transportation option module 242, and an itinerary module 244, collectively referred to herein as “modules 230”. The travel plan application 202, including the modules 230, may generally include software that includes programming code and/or computer-readable instructions executable by the processor device 204 to perform or control performance of the functions and operations described herein. The travel plan application 202, including one or more of the modules 230, may receive data from another one of the components of the system 200 and may store the data in one or both of the storage 208 and the memory 210.

With combined reference to FIGS. 1-3, the content source analysis module 232 may generally be configured to access one or more content sources 110, 220 and analyze them for one or more potential places to visit 302, as well as identify content attributes 312 for each identified potential place to visit 302, as described in more detail herein. The coordinate module 234 may generally be configured to access coordinates 314 or other geographic location data from one or more coordinate databases 108, determine whether each potential place to visit 302 has a physical location with coordinates and tag or associate the coordinates 314 to their respective potential place to visit 302, as described in more detail herein. The content attribute module 236 may generally be configured to assign weight values 316 to each content attribute 312, sum all weighted content attributes 312 for each potential place to visit 302 creating a content attribute score 318 for each potential place to visit 302, and prioritize the potential places to visit 302 with respect to each other based on their respective content attribute scores 318, as described in more detail herein. The travel attribute module 238 may generally be configured to access travel attributes 320 from the travel attribute databases 126 and identify travel attributes 320 for each potential place to visit 302, assign weight values 316 to each identified travel attribute 320, sum all weighted travel attributes 320 for each potential place to visit 302 creating a travel attribute score 322 for each potential place to visit 302, combine the content attribute score 318 with the travel attribute score 322 for each potential place to visit 302 resulting in a combined attribute score 324 for each potential place to visit 302, and prioritize each potential place to visit 302 with respect to each other based on their respective combined attribute scores 324, as described in more detail herein. The content source ranking module 240 may generally be configured to tag each potential place to visit 302 with a content source identifier 326, sum all combined attribute scores 324 for each potential place to visit 302 that has the same content source identifier 326 resulting in a content source score 328 for each content source, and prioritize each content source with respect to each other based on their respective content source scores 328. The transportation option module 242 may generally be configured to access transportation options 330 from one or more transportation option databases, identify one or more transportation options 330 between potential places to visit 302, and provide the one or more transportation options 330 to an output device for display on a map. The itinerary module 244 may generally be configured to create a travel plan itinerary showing a list of the potential places to visit 302 that the traveler has chosen, the order for visiting each potential place to visit 302, and the chosen transportation options 330 between each potential place to visit 302.

An example implementation involving a traveler that has the personal travel plan profile 300 of FIG. 3 as one of the personal travel plan profiles 222 stored in the memory 210 of FIG. 2 will now be discussed with combined reference to FIGS. 2 and 3.

The input module 214 may receive input from the traveler 122 effective to indicate at least one content source to analyze for potential places to visit 302. The input module 214 may receive the input through a user interface of the system 200, which user interface may include a mouse, keyboard, touchpad, touchscreen, graphical user interface, or other input device. In some implementations, the traveler may directly select one or more content sources to analyze for potential places to visit 302 via the input module 214. In other implementations, the traveler may select one or more geographic locations that the traveler may desire to visit and the travel plan application 202 may be configured to automatically search all content sources (or a subset of content sources) that are associated with the traveler for potential places to visit 302 with coordinates 314 that appear within the selected geographic location(s) and then display the potential places 302 to visit with coordinates 314 that fall within the selected geographic location(s) on a map through the display device 216. In some implementations, the input module 214 includes a graphical user interface displayed to the traveler through the display device 216 and the graphical user interface may be configured to simultaneously receive input from the traveler 112 as well as display output to the traveler. For example, a portion of the graphical user interface may be configured to receive traveler inputs, such as content source selections, geographic area selections, time frame selections, etc., while another portion of the graphical user interface may be configured to display outputs to the traveler, such as lists of potential places to visit 302, lists of content sources with potential places to visit 302 that lie within geographic locations, maps showing the locations of potential places to visit 302, travel attribute data associated with potential places to visit 302, transportation options 330 between potential places to visit 302, travel plan itinerary data, etc.

After the input module 214 has received input from the traveler 122 effective to indicate at least one content source to analyze for potential places to visit 302, the content source analysis module 232 may access the selected content source(s) and analyze them for potential places to visit 302. The content source analysis module 232 may use natural language processing techniques, such as named entity recognition techniques, to analyze the content source(s) and identify potential places to visit 302. The content analysis module 232 may also tag each potential place to visit 302 with a content source identifier 326 indicating which content source a potential place to visit 302 was found in. Alternatively, or in addition thereto, the content source ranking module 240 may tag each potential place to visit 302 with a content source identifier 326, as will be discussed in more detail below. The content analysis module 232 may also identify one or more content attributes 318 associated with each potential place to visit 302 and tag the content attributes 318 to their respective potential place to visit 302. As discussed previously, content attributes 318 may include, but are not limited to: the number of times a potential place to visit 302 appears in a content source, whether the traveler highlighted the potential place to visit 302 in a content source (and/or how many times), whether the traveler annotated a potential place to visit 302 in a content source (and/or how many times), whether the traveler performed a search for a potential place to visit 302 (e.g., dictionary search, Wikipedia® search, a video search, an image search, a web search, etc., and/or how many times the user performed the search for the potential place to visit 302), and whether the traveler shared or otherwise discussed a potential place to visit 302 (e.g., via email, Facebook®, Twitter®, SMS text message, blog, etc., and/or how many times the user shared or discussed the potential place to visit).

The coordinate module 234 may determine whether each of the potential places to visit 302 extracted from the selected content source(s) has a physical location with coordinates. The coordinate module 234 may access one or more coordinate databases 108 and search for coordinates, or other geographic location data, for each potential place to visit 302. As discussed previously, the coordinate databases 108 may be obtained from or based on any website that contains coordinate or geographic location data for potential places to visit 302, such as Google Maps® and Wikipedia®, or from other suitable sources. If the coordinate module 234 finds coordinates for a potential place to visit 302 within the coordinate databases 108, the coordinate module 234 may tag the potential place to visit 302 with its respective coordinates 314.

The content attribute module 236 may assign weight values 316 to each content attribute 312 associated with a potential place to visit 302 with coordinates 314. The weight value 316 may depend on the type of content attribute 312. For example, it may be determined that a potential place to visit 302 that is highlighted in a content source is to be given greater weight than a potential place to visit 302 which merely appears in the content source. The content attribute module 236 may sum up all of the weighted content attributes 312 for each potential place to visit 302 with coordinates 314 and calculate a content attribute score 318 for each potential place to visit 302. The content attribute module 236 may also prioritize the potential places to visit 302 with respect to each other based on their respective content attribute scores 318.

The travel attribute module 238 may determine whether each of the potential places to visit 302 extracted from the selected content source(s) has any associated travel attributes 320. As previously discussed, travel attributes 320 may include, but are not limited to: ratings, hours of operation, suggested duration for a visit, price, descriptions, helpful tips, etc. The travel attribute databases 126 may be obtained from or based on any website that contains travel attribute information or any other useful information related to potential places to visit 302, such as travel websites, blogs, or other suitable sources. The travel attribute module 238 may access the one or more travel attribute databases 126 and search them for travel attributes 320 associated with each potential place to visit 302 that has coordinates 314. If the travel attribute module 238 finds travel attribute(s) 320 for a potential place to visit 302 with coordinates 314 in the travel attribute database(s) 126, the travel attribute module 238 may tag the potential place to visit 302 with its respective travel attribute(s) 320.

The travel attribute module 238 may also assign weight values 316 to each travel attribute 320 associated with a potential place to visit 302 with coordinates 314. The weight value 316 may depend on the type of travel attribute 320. For example, it may be determined that travel attributes 320 for a potential place to visit 302, such as ratings or reviews, are to be given greater weight than other travel attributes 320, such as a suggested duration for visiting a potential place to visit 302. The travel attribute module 238 may sum up all of the weighted travel attributes 320 for each potential place to visit 302 with coordinates 314 and calculate a travel attribute score 322 for each potential place to visit 302. The travel attribute module 238 may combine the travel attribute scores 322 with the content attribute scores 318 for each potential place to visit 302 and calculate a combined attribute score 324 for each potential place to visit 302. The travel attribute module 238 may prioritize the potential places to visit 302 with respect to each other based on their respective combined attribute scores 324.

The travel plan application 202 may output prioritized lists of potential places to visit 302 with coordinates 314 to an output device, such as display 216. The prioritized lists of potential places to visit 302 with coordinates 314 may be based on their combined attribute scores 324, their travel attribute scores 322, and/or their content attribute scores 318. The traveler may select potential places to visit 302 from the prioritized lists and the travel plan application 202 may show the selected potential places to visit 302 on a map. The traveler may also select his or her preferred order for visiting each of the selected potential places to visit 302 and the travel plan application 202 may show the preferred order for visiting each of the selected potential places on the display 216.

The transportation option module 242 may access transportation options 330 from one or more transportation option databases (not shown). The transportation option databases may include any website that contains transportation option information between potential places to visit 302 such as Google Maps®, or any other suitable source. The transportation option module 242 may identify one or more transportation options 330 between each selected potential place to visit 302. The transportation option module 242 may provide the identified transportation options 330 for output to the display device 216. The transportation options 330 between selected potential places may be displayed with the prioritized lists of potential places to visit 302. Alternatively, or additionally thereto, the transportation options 330 may be displayed on the map with the selected potential places to visit 302. The traveler may select his or her preferred transportation options 330 between each of the different potential places to visit 302 he or she has selected.

The itinerary module 244 may create a travel plan itinerary based on the traveler's selected potential places to visit 302, desired order for visiting each potential place to visit 302, and selected transportation options 330 between each of the potential places to visit 302. The travel plan itinerary may also include other information, including travel attributes 320 for selected potential places to visit 302, time periods to stay at each potential place to visit 302, associated transportation option information such as price, arrival and departure times, schedules, pick-up and drop-off locations, estimated travel times between each potential place to visit 302, and the like.

In some implementations, the travel plan application 202 may also include a content source ranking module 240. The content source ranking module 240 may tag each potential place to visit 302 with a content source identifier 326 which identifies the content source where the potential place to visit 302 was located. Alternatively, or in addition thereto, the content source analysis module 232 may also tag each potential place to visit 302 with a content source identifier 326. This implementation may be useful when the traveler knows the geographic location(s) that the traveler will be visiting, but the traveler may not yet know which content source(s) have potential places to visit 302 with coordinates 314 that pertain to those geographic location(s). Thus, the traveler may desire that the travel plan application 202 be configured to search all of his or her associated content sources, or a subset thereof, to find all of the potential places to visit 302 with coordinates 314 that fall within the selected geographic location(s). The traveler may also desire to know which content source(s) have the most potential places to visit 302, or the most relevant potential places to visit 302, for the selected geographic location(s). The traveler may further desire to know which potential places to visit 302 correspond to which content source(s). This information may help the traveler further narrow down and select one or more content sources. The content source ranking module 240 may sum up all of the combined attribute scores 324 for each potential place to visit 302 that falls within the selected geographic area that has the same content source identifier 326 and calculate a content source score 328 for each content source with potential places to visit 302 that fall within the selected geographic area. The content source ranking module 240 may prioritize the content sources with respect to each other based on their respective content source scores 328 and provide a prioritized list of the content sources to the travel plan application 202 to output to a device, such as display 216. The traveler may select one or more content sources from this prioritized list and view the potential places to visit 302 that correspond to the selected content sources. In this manner, the traveler may further narrow down his or her selection of content sources.

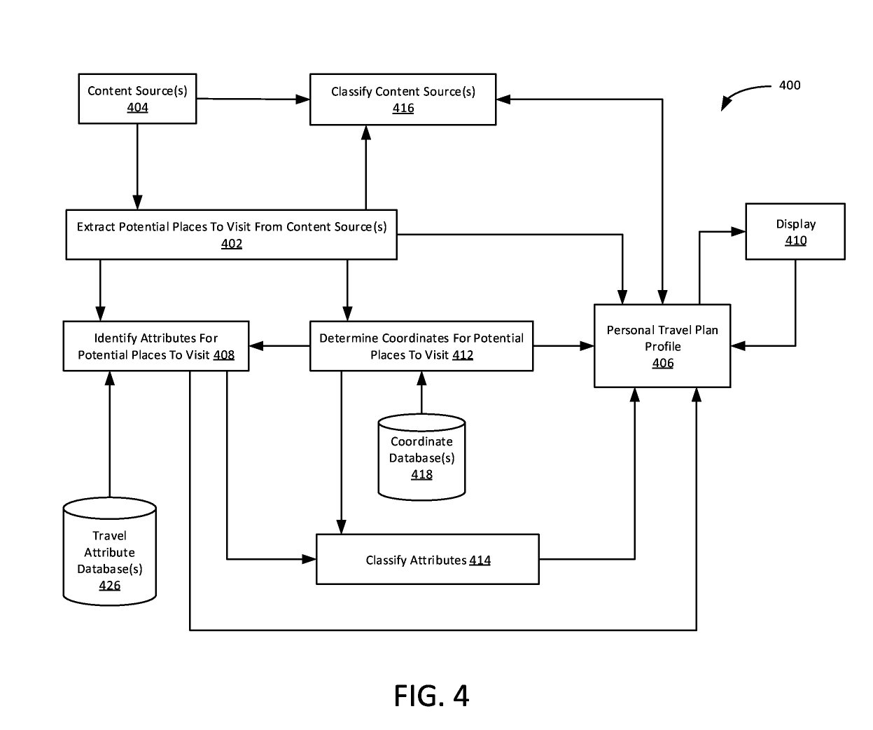

FIG. 4 shows an example flow diagram of a method 400 to build a personalized content-based travel plan, arranged in accordance with at least one implementation described herein. The method 400 may be implemented, in whole or in part, by one or more of the traveler devices 104 or travel server 106 of FIG. 1, the system 200 of FIG. 2, or another suitable device, server, and/or system. The method 400 may begin at block 402.

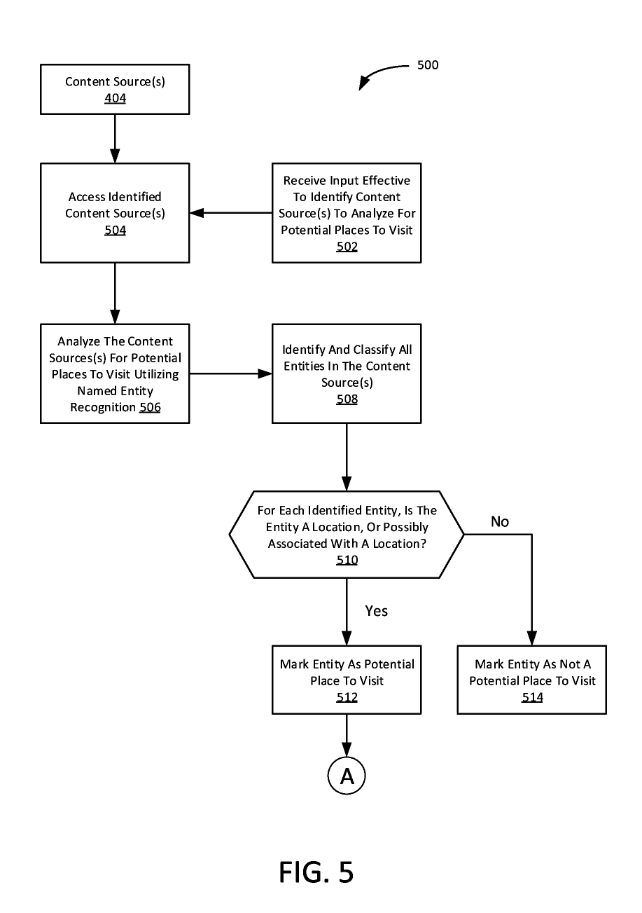

In block 402 (“Extract Potential Places To Visit From Content Source(s)”), one or more content sources 404 may be accessed and analyzed for potential places to visit 302. The traveler may select the one or more content sources 404 that are to be the subject of analysis for potential places to visit 302. Alternatively, or in addition thereto, the one or more content sources 404 may be automatically selected by the program or based on the traveler preferences 310, as discussed previously with reference to FIG. 3. The one or more content sources 404 may correspond to the content sources 110 of FIG. 1, the content sources 220 of FIG. 2, or other content sources described herein. The personal travel plan profile 406 may be included in or correspond to the personal travel plan profile(s) 124 of FIG. 1, the personal travel plan profile(s) 222 of FIG. 2, the personal travel plan profile 300 of FIG. 3, or other personal travel plan profiles described herein. The potential places to visit 302 extracted from the content source(s) may be added to the personal travel plan profile 406 to update the personal travel plan profile 406. In these and other implementations, updating the personal travel plan profile 406 may be accomplished by sending a write command to a memory or storage on which the personal travel plan profile 406 is stored. An example method to analyze content source(s) 404 for potential places to visit 302 is described with respect to FIG. 5. Block 402 may be followed by blocks 408 or 412.

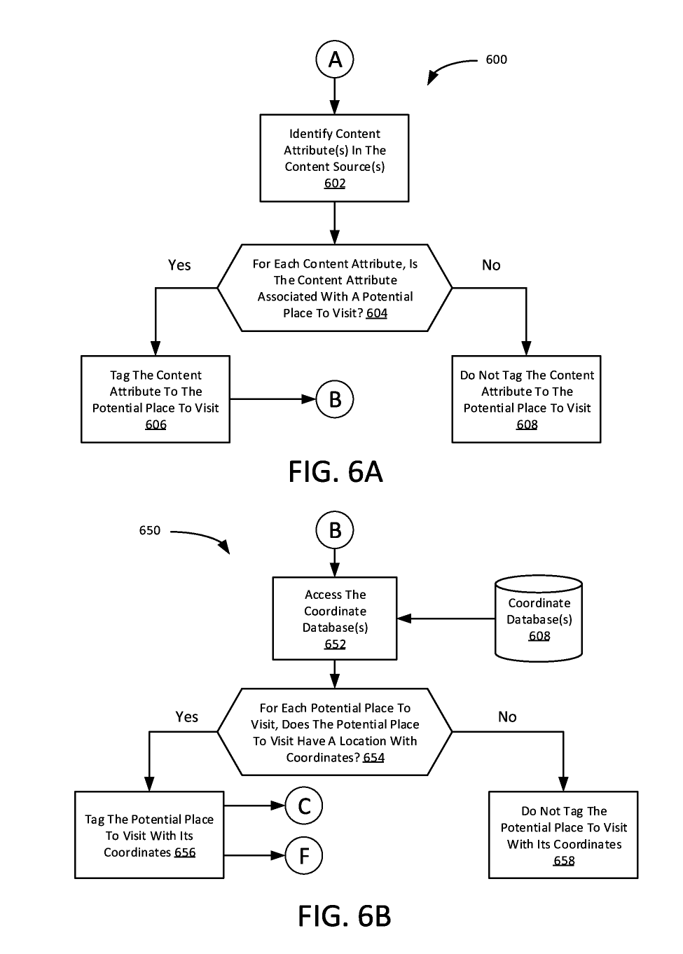

In block 408 (“Identify Attributes For Potential Places To Visit”), one or more content attributes may be identified for each of the extracted potential places to visit 302. The content attributes may correspond to the content attributes 312 of FIG. 3. The content attributes 312 may be identified in the same content source where the potential place to visit 302 was extracted. The content attributes 312 may indicate a level of prominence or importance that a potential place to visit 302 may have within a content source. For example, the content attribute 312 may be the number of times the potential place to visit 302 appears in the content source, or the content attribute 312 may indicate that the traveler has expressed some level of interest in the potential place to visit 302. For example, the content attribute 312 may indicate whether the traveler highlighted the potential place to visit 302 in the content source (and/or how many times), whether the traveler annotated the potential place to visit 302 in the content source (and/or how many times), whether the traveler performed a search for the potential place to visit 302 (e.g., dictionary search, Wikipedia® search, a video search, an image search, a web search, etc., and/or how many times the user performed a search for the potential place to visit 302), and whether the traveler shared or otherwise discussed the potential place to visit 302 (e.g., via email, Facebook®, Twitter®, SMS text message, blog, etc., and/or how many times the user shared or discussed the potential place to visit 302). The content attributes 312 may be tagged to their respective potential place to visit 302 by adding the content attributes 312 to the personal travel plan profile 406 and associating each content attribute 312 with its respective potential place to visit 302. An example method to identify content attributes 312 for potential places to visit 302 is described with respect to FIG. 6A.

In block 412 (“Determine Coordinates For Potential Places To Visit”), it may be determined whether each of the extracted potential places to visit 302 has a physical location with coordinates 314 and if so, each potential place to visit 302 may be tagged with its respective coordinates 314. One or more coordinate databases 418 may be accessed and searched for coordinates or other geographic location data for each potential place to visit 302. The one or more coordinate databases 418 may correspond to the coordinate databases 108 of FIG. 1. If coordinates 314 are found for a potential place to visit 302, the coordinates 314 may be associated with the potential place to visit 302 and added to the personal travel plan profile 406. An example method to identify coordinates for potential places to visit 302 is described with respect to FIG. 6B. Block 412 may be followed by block 408 (discussed previously) or by block 414.

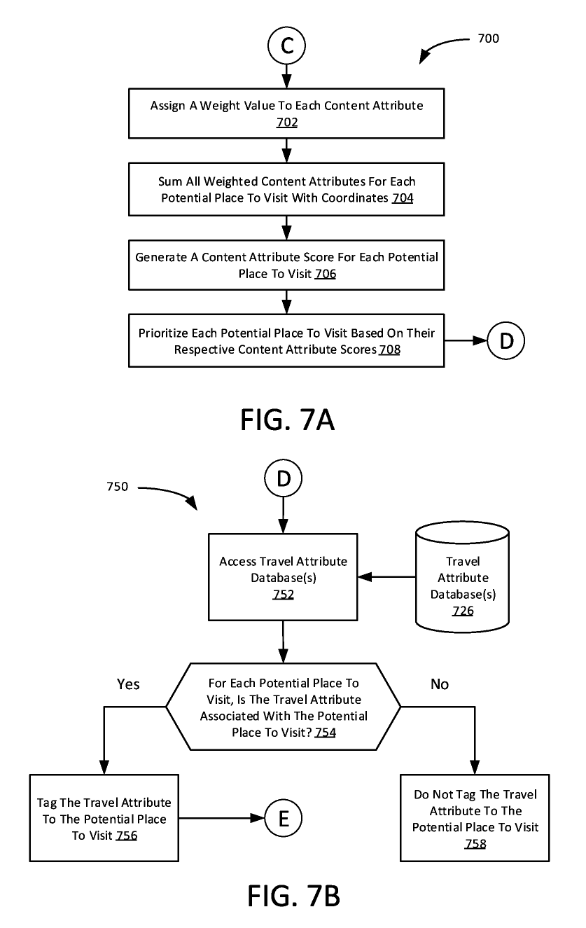

In block 408 (“Identify Attributes For Potential Places To Visit”), one or more travel attributes may be identified for each of the extracted potential places to visit 302 and tagged to their respective potential place to visit 302. In some implementations, searches for travel attributes may only be performed for those potential places to visit 302 that have coordinates 314. The travel attributes may correspond to the travel attributes 320 of FIG. 3. One or more travel attribute databases 426 may be accessed and searched for travel attributes 320 for each potential place to visit 302. The one or more travel attribute databases 426 may correspond to the travel attribute databases 126 of FIG. 1. The travel attributes 320 may include useful information about each potential place to visit 302 which may help the traveler learn about a potential place to visit 302. For example, the travel attributes 320 may include information such as ratings, hours of operation, suggested duration for a visit, price, descriptions, helpful tips, etc. The travel attributes 320 may be tagged to their respective potential place to visit 302 by adding the travel attributes 320 to the personal travel plan profile 406 and associating each travel attribute 320 with its respective potential place to visit 302. An example method to identify travel attributes 320 for potential places to visit 302 is described with respect to FIG. 7B. Block 408 may be followed by block 414.

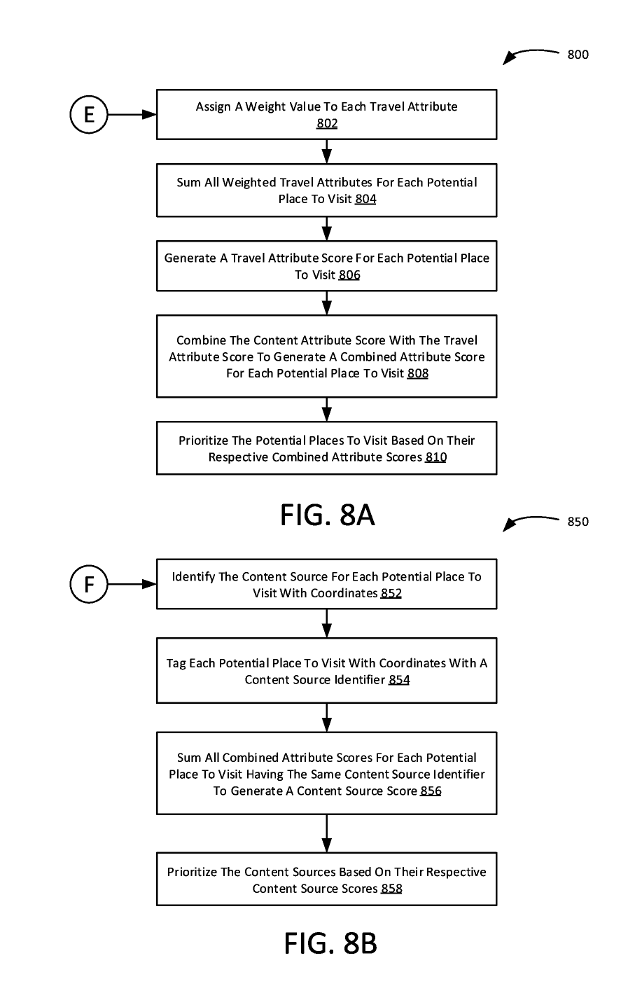

In block 414 (“Classify Attributes”), the content attributes 312 and travel attributes 320 associated with each potential place to visit 302 may be classified to prioritize each potential place to visit 302 with respect to each other. Weight values may be applied to each content attribute 312 and travel attribute 320. The weight values may correspond to the weight values 316 of FIG. 3. The weighted content attributes 312 for each potential place to visit 302 may be summed together to create a content attribute score 318. The weighted travel attributes 320 for each potential place to visit 302 may be summed together to create a travel attribute score 322. The content attribute score 318 and travel attribute score 322 for each potential place to visit 302 may be summed together to create a combined attribute score. The content attribute score 318, travel attribute score 322, and combined attribute score may each correspond to the content attribute score 318, travel attribute score 322, and combined attribute score 324 of FIG. 3. The content attribute scores 318, travel attribute scores 322, and combined attribute scores 324 may be tagged to their respective potential place to visit 302 by adding them to the personal travel plan profile 406 and associating them with their respective potential place to visit 302. Prioritized lists of potential places to visit 302 may be created from the content attribute scores 318, travel attribute scores 322, and/or combined attribute scores 324 associated with each potential places to visit 302. These prioritized lists of potential places to visit 302 may be added to, and/or derived from, the personal travel plan profile in block 406. An example method to classify content attributes 312 for potential places to visit 302 is described with respect to FIG. 7A. An example method to classify travel attributes 320 for potential places to visit 302 is described with respect to FIG. 8A. Block 414 and 406 may be followed by block 410.

In block 410 (“Display”), the prioritized lists of potential places to visit 302 may be presented to the traveler. Alternatively, or in addition thereto, potential places to visit 302 may be directly presented to the user on a map in block 410. In one example, the traveler may select one or more potential places to visit 302 from the prioritized lists of potential places to visit 302 displayed in block 410 and, in response to the traveler's selection, the selected potential places to visit 302 may be displayed on the map. The traveler may also select the desired visit order for visiting each of the selected potential places to visit 302. The desired visit order data may be added to the personal travel plan profile 406. Transportation options 330 may also be displayed between each of the selected potential places to visit 302 on the map and the traveler may select the desired transportation options 330 between each of the selected potential places to visit 302. The transportation options 330 may correspond to the transportation options 330 of FIG. 3. A travel plan itinerary may be created from the traveler's selection data and the traveler's personal travel plan profile 406 data and then displayed to the traveler. The travel plan itinerary may include a list of the selected potential places to visit 302, the desired visit order for visiting each of the selected potential places to visit 302, and the selected transportation options 330 between each of the selected potential places to visit 302. The travel plan itinerary may also include additional data, such as visit times for each selected potential place to visit 302, travel attribute information for each selected potential place to visit 302, and/or additional transportation option data such as price, pick-up and drop-off locations, travel time estimates, etc.

In some implementations, block 402 may be additionally followed by block 416 (“Classify Content Source(s)”). In block 416, the content source(s) may be classified to prioritize each content source with respect to each other. This may help the traveler to further narrow down his or her content source selections. Each of the potential places to visit 302 may be tagged with a content source identifier which identifies the content source from which the potential place to visit 302 was extracted. The content source identifiers may correspond to the content source identifiers 326 shown in FIG. 3. The content source identifiers 326 may be associated with their respective potential place to visit 302 and added to the personal travel plan profile 406. The combined attribute scores 324 for each potential place to visit 302, having the same content source identifier, may be summed together to create a content source score for each content source. The combined attribute scores 324 and content source scores may each correspond to the combined attribute scores 324 and content source scores 328 of FIG. 3. The content source scores 328 may be added to the personal travel plan profile 406. Prioritized lists of content sources may be created from the content source scores 328. The prioritized lists of content sources may be added to, and/or derived from, the personal travel plan profile in block 406. Prioritized lists of content sources may be displayed to the traveler in block 410. The traveler may select one or more content sources from a prioritized list of content sources that is displayed in block 410 and, in response to the traveler's selection, the potential places to visit 302 corresponding to the selected content source(s) may be displayed in prioritized lists and/or on the map as described previously. In this manner, the traveler may compare and contrast the potential places to visit 302 that are associated with different content sources. This information may help the traveler further narrow down his or her content source selection(s). An example method to classify content sources is described with respect to FIG. 8B below.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed implementations.

FIG. 5 shows an example flow diagram of a method 500 to extract potential places to visit 302 from content sources, arranged in accordance with at least one implementation described herein. The method 500 may be implemented, in whole or in part, by one or more of the traveler devices 104 or travel server 106 of FIG. 1, the system 200 of FIG. 2, or another suitable device, server, and/or system. The method 500 may begin at block 502.

In block 502 (“Receive Input Effective To Identify Content Source(s) To Analyze For Potential Places To Visit”), input may be received from the traveler which may be effective to indicate one or more content sources 404 to analyze for potential places to visit 302. For example, input from the traveler may include a selection of one or more content sources 404. In another example, input from the traveler may include a selection of one or more geographic locations that the traveler desires to visit. This example may be advantageous when the traveler knows the geographic location(s) that the traveler will be visiting, but the traveler may not know which content source(s) have potential places to visit 302 with coordinates 314 pertaining to those geographic location(s). In this example, all of the traveler's content sources, or a subset thereof, may be selected for analysis of potential places to visit 302 within the content sources. As discussed previously with reference to FIGS. 2 and 3, the traveler preferences 310 may include data or settings to indicate whether all or a subset of the traveler's content sources are to be searched for potential places to visit 302 when the traveler performs searches by geographic location. For example, the traveler may desire to search a subset of the content sources associated with the traveler (e.g., such as the traveler's ebooks, or particular content source(s)) for potential places to visit 302 that fall within a geographic location. Block 502 may be followed by block 504.

In block 504 (“Access Identified Content Source(s)”), the selected or indicated content source(s) 404 may be accessed. For example, content source(s) 404 may be accessed by the content source analysis module 232 of FIG. 2. The content source(s) 404 may correspond to the content source(s) 110 and 220 of FIGS. 1 and 2. Block 504 may be followed by block 506.

In block 506 (“Analyze The Content Sources(s) For Potential Places To Visit Utilizing Named Entity Recognition”), the content source(s) 404 may be analyzed for potential places to visit 302. For example, the content source analysis module 232 of FIG. 2 may be used to analyze the content sources with natural language processing techniques, such as named entity recognition, to identify potential places to visit 302. Block 506 may be followed by block 508.

In block 508 (“Identify And Classify All Entities In The Content Source(s)”), all entities may be identified in the content sources 404 and classified. For example, the content source analysis module 232 of FIG. 2 may be used to identify and classify all entities in the content sources. The entities in the content sources may be nouns or proper nouns that are contained within the content sources. The entities may be further classified into different categories such as people, places, events, objects, dates, etc. Each entity identified in the content sources 404 may be tagged with one or more category descriptors that identify a type or category associated with the entity. For example the category descriptors may include, but are not limited to: person, place, event, object, date, time, building, historical site, burial site, naturally occurring feature or object, non-fictional, fictional, etc. Block 508 may be followed by block 510.

In block 510 (“For Each Identified Entity, Is The Entity A Location, Or Possibly Associated With A Location?”), each identified entity may be analyzed to determine whether the entity may represent a potential place to visit 302. For example, the content source analysis module 232 of FIG. 2 may be used to analyze each entity and determine whether the identified entity is a location, or possibly associated with a location, such that the entity may represent a potential place to visit 302. In one implementation, the category descriptors for each entity may be analyzed to determine whether the entity may represent a potential place to visit 302. For example, the category descriptors may be searched for entities that have the category descriptor “fiction” associated with the entity. If so, the entity may not represent a potential place to visit 302, as will be discussed below with reference to block 512 and 514 below.

Following block 510, the method 500 may branch depending on whether the entity is a location, or possibly associated with a location. If it is determined that the entity is a location, or possibly associated with a location (“Yes” at block 510 in FIG. 5), the method 500 may proceed to block 512. If it is determined that the entity is not a location and not associated with a location (“No” at block 510 in FIG. 5) the method 500 may proceed to block 514.

In block 512 (“Mark Entity As Potential Place To Visit”), and responsive to the determination that the entity is a location, or possibly associated with a location, the entity may be marked as a potential place to visit 302.

In block 514 (“Mark Entity As Not A Potential Place To Visit”), and responsive to the determination that the entity is not a location and not associated with a location, the entity may marked as “not” a potential place to visit 302, or not marked at all.

FIG. 6A shows an example flow diagram of a method 600 to extract content attributes 312 for the potential places to visit of FIG. 5, arranged in accordance with at least one implementation described herein. The method 600 may be implemented, in whole or in part, by one or more of the traveler devices 104 or travel server 106 of FIG. 1, the system 200 of FIG. 2, or another suitable device, server, and/or system. The method 600 may begin at block 602. Alternatively, or in addition thereto, and as indicated by a circular block “A” in each of FIGS. 5 and 6A, block 602 of FIG. 6A may follow block 512 of FIG. 5.

In block 602 (“Identify Content Attribute(s) In The Content Source(s)”), content attributes 312 may be identified in the content source(s) 404. For example, the content source analysis module 232 of FIG. 2 may be used to identify content attributes 312 in the content sources. The content attributes 312 may correspond to the content attributes 312 of FIG. 3. The content attributes 312 may generally indicate entities in the content sources 404 that the traveler has identified, or otherwise expressed some interest in. For example, content attributes 312 may include the number of times an entity appears in the content source, whether the traveler highlighted an entity in the content source (and/or how many times), whether the traveler annotated an entity in the content source (and/or how many times), and whether the traveler performed a search for an entity (and/or how many times), whether the traveler shared or otherwise discussed an entity (and/or how many times), etc. Block 602 may be followed by block 604.

In block 604 (“For Each Content Attribute, Is The Content Attribute Associated With A Potential Place To Visit?”), it may be determined if the content attribute 312 is associated with an entity that may be a potential place to visit 302. For example, the content source analysis module 232 of FIG. 2 may be used to determine if the content attribute 312 is associated with an entity that may be a potential place to visit 302. Furthermore, the results of the method 500 of FIG. 5 may be used to determine if the content attribute 312 is associated with an entity that may be a potential place to visit 302.

Following block 604, the method 600 may branch depending on whether the content attribute 312 is associated with an entity that may be a potential place to visit 302. If it is determined that the content attribute 312 is associated with an entity that may be a potential place to visit 302 (“Yes” at block 604 in FIG. 6A), the method 600 may proceed to block 606. If it is determined that the content attribute 312 is not associated with an entity that may be a potential place to visit 302 (“No” at block 604 in FIG. 6A) the method 600 may proceed to block 608.

In block 606 (“Tag The Content Attribute To The Potential place to visit 302”), and responsive to the determination that the content attribute 312 is associated with an entity that may be a potential place to visit 302, the content attribute 312 may be tagged to the entity that may be a potential place to visit 302.

In block 608 (“Do Not Tag The Content Attribute To The Potential Place To Visit”), and responsive to the determination that the content attribute 312 is not associated with an entity that may be a potential place to visit 302, the content attribute 312 may not be tagged to the entity. Alternatively, or in addition thereto, the content attribute 312 may be tagged to the entity, and the entity and/or associated content attribute 312 may be marked as “Not a potential place to visit.”

Alternatively, potential places to visit 302 may be identified prior to identifying content attributes 312 in the content sources. In this and other implementations, the content attributes 312 may then only be identified for entities that have been identified as potential places to visit 302, rather than for every entity in the content sources 404, to reduce processing overhead.

FIG. 6B shows an example flow diagram of a method 650 to determine location coordinates for the potential places to visit 302 found in method 500 of FIG. 5, arranged in accordance with at least one implementation described herein. The method 650 may be implemented, in whole or in part, by one or more of the traveler devices 104 or travel server 106 of FIG. 1, the system 200 of FIG. 2, or another suitable device, server, and/or system. The method 650 may begin at block 652. Alternatively, or in addition thereto, and as indicated by a circular block “B” in each of FIGS. 6A and 6B, block 652 of FIG. 6B may follow block 606 of FIG. 6A.

In block 652 (“Access The Coordinate Database(s)”), one or more coordinate databases 608 may be accessed. For example, the coordinate module 234 of FIG. 2 may be used to access the coordinate databases 608. The one or more coordinate databases 608 may correspond to the one or more coordinate databases 108 of FIG. 1. Block 652 may be followed by block 654.

In block 654 (“For Each Potential Place To Visit, Does The Potential Place To Visit Have A Location With Coordinates?”), it may be determined if each potential place to visit 302 has a physical location with coordinates 314. For example, the coordinate module 234 of FIG. 2 may be used to determine if each potential place to visit 302 has a physical location with coordinates 314. The coordinate databases 608 may be searched by the coordinate module 234 for coordinates associated with each potential place to visit 302 identified in the method 500 of FIG. 5 to determine whether each potential place to visit 302 has a physical location with coordinates.

Following block 654, the method 650 may branch depending on whether coordinates 314 were found for each potential place to visit 302. If it is determined that a potential place to visit 302 has coordinates 314 (“Yes” at block 654 in FIG. 6B), the method 650 may proceed to block 656. If it is determined that a potential place to visit 302 does not have coordinates 314 (“No” at block 654 in FIG. 6B) the method 650 may proceed to block 658.

In block 656 (“Tag The Potential Place To Visit With Its Coordinates”), and responsive to the determination that a potential place to visit 302 has coordinates 314, the potential place to visit 302 may be tagged with its coordinates 314.

In block 658 (“Do Not Tag The Potential Place To Visit With Its Coordinates”), and responsive to the determination that a potential place to visit 302 does not have coordinates 314, the potential place to visit 302 may not be tagged with its coordinates 314. Alternatively, or in addition thereto, the potential place to visit 302 may be tagged as a potential place to visit 302 that does not have coordinates 314.

Although the method 650 of FIG. 6B has been described as occurring after the method 600 of FIG. 6A, in other implementations, the method 650 of FIG. 6B may occur simultaneously or overlap with the method 600 of FIG. 6A, or the method 650 of FIG. 6B may occur prior to the method 600 of FIG. 6A. For example, after marking an entity as a potential place to visit 302 in block 512 of FIG. 5, the method 650 of FIG. 6B may be executed for each of the potential places to visit 302 to tag potential places to visit 302 that have coordinates with coordinates 314. Then, the method 600 of FIG. 6A may be executed for each of the coordinate-tagged potential places to visit 302 to identify and tag content attributes 312 to each of the coordinate-tagged potential places to visit 302. In this manner, processing overhead may be reduced by only identifying and tagging content attributes 312 for potential places to visit 302 that have coordinates 314, rather than for every potential place to visit 302 (some of which may not have coordinates 314).

FIG. 7A shows an example flow diagram of a method 700 to classify the potential places to visit 302 of FIG. 5 based on their content attribute scores 318, arranged in accordance with at least one implementation described herein. The method 700 may be implemented, in whole or in part, by one or more of the traveler devices 104 or travel server 106 of FIG. 1, the system 200 of FIG. 2, or another suitable device, server, and/or system. The method 700 may begin at block 702. Alternatively, or in addition thereto, and as indicated by a circular block “C” in each of FIGS. 6B and 7A, block 702 of FIG. 7A may follow block 656 of FIG. 6B.

In block 702 (“Assign A Weight Value To Each Content Attribute”), a weight value 316 may be assigned to each content attribute 312 associated with a potential place to visit 302 with coordinates 314. For example, the content attribute module 236 of FIG. 2 may be used to assign a weight value 316 to each content attribute 312. The content attributes 312 and weight values 316 may correspond to the content attributes 312 and weight values 316 of FIG. 3. Block 702 may be followed by block 704.

In block 704 (“Sum All Weighted Content Attributes For Each Potential Place To Visit With Coordinates”), all weighted content attributes 312 may be summed together for each potential place to visit 302 with coordinates 314. For example, the content attribute module 236 of FIG. 2 may be used to sum together all weighted content attributes 312 for each potential place to visit 302 with coordinates 314. Block 704 may be followed by block 706.

In block 706 (“Generate A Content Attribute Score For Each Potential Place To Visit”), a content attribute score 318 for each potential place to visit 302 with coordinates 314 may be generated. For example, the content attribute module 236 of FIG. 2 may be used to generate the content attribute scores 318. The content attribute scores 318 may correspond to the content attribute scores 318 of FIG. 3. The content attribute scores 318 may include the sum of all of the weighted content attributes 312 for each potential place to visit 302 with coordinates 314. More particularly, the content attribute score 318 for each potential place to visit 302 with coordinates 314 may include the sum of all the weighted content attributes 312 for that potential place to visit 302 with coordinates 314. Block 706 may be followed by block 708.

In block 708 (“Prioritize Each Potential Place To Visit Based On Their Respective Content Attribute Scores”), each potential place to visit 302 with a content attribute score 318 may be prioritized with respect to each other based on their respective content attribute scores 318. For example, the content attribute module 236 of FIG. 2 may be used to prioritize each potential place to visit 302 with a content attribute score 318 with respect to each other based on their respective content attribute scores 318.

FIG. 7B shows an example flow diagram of a method 750 to identify travel attributes for the potential places to visit 302 of FIG. 5, arranged in accordance with at least one implementation described herein. The method 750 may be implemented, in whole or in part, by one or more of the traveler devices 104 or travel server 106 of FIG. 1, the system 200 of FIG. 2, or another suitable device, server, and/or system. The method 750 may begin at block 752. Alternatively, or in addition thereto, and as indicated by a circular block “D” in each of FIGS. 7A and 7B, block 752 of FIG. 7B may follow block 708 of FIG. 7A.

In block 752 (“Access Travel Attribute Database(s)”), one or more travel attribute databases 726 may be accessed. For example, the travel attribute module 238 of FIG. 2 may be used to access the travel attribute databases 726. The one or more travel attribute databases 726 may correspond to the one or more travel attribute databases 126 of FIG. 1. Block 752 may be followed by block 754.

In block 754 (“For Each Potential Place To Visit, Is The Travel Attribute Associated With The Potential Place To Visit?”), it may be determined if each potential place to visit 302 is associated with one or more travel attributes. For example, the travel attribute module 238 of FIG. 2 may be used to search the travel attribute databases 726 and determine if each potential place to visit 302 identified in method 500 of FIG. 5 has one or more travel attributes. The travel attributes may correspond to the travel attributes 320 of FIG. 3.

Following block 754, the method 750 may branch depending on whether travel attributes 320 were found for each potential place to visit 302. If it is determined that a potential place to visit 302 has travel attributes 320 (“Yes” at block 754 in FIG. 7B), the method 750 may proceed to block 756. If it is determined that that a potential place to visit 302 does not have travel attributes 320 (“No” at block 754 in FIG. 7B) the method 750 may proceed to block 758.

In block 756 (“Tag The Travel Attribute To The Potential Place To Visit”), and responsive to the determination that a potential place to visit 302 has travel attributes 320, the potential place to visit 302 may be tagged with its respective travel attributes 320.

In block 758 (“Do Not Tag The Travel Attribute To The Potential Place To Visit”), and responsive to the determination that a potential place to visit 302 does not have travel attributes 320, the potential place to visit 302 may not be tagged with its respective travel attributes 320. Alternatively, or in addition thereto, the potential place to visit 302 may be tagged as a potential place to visit 302 that does not have travel attributes 320.

FIG. 8A shows an example flow diagram of a method 800 to classify the potential places to visit 302 of FIG. 5 based on their combined attribute scores 324, arranged in accordance with at least one implementation described herein. The method 800 may be implemented, in whole or in part, by one or more of the traveler devices 104 or travel server 106 of FIG. 1, the system 200 of FIG. 2, or another suitable device, server, and/or system. The method 800 may begin at block 802. Alternatively, or in addition thereto, and as indicated by a circular block “E” in each of FIGS. 7B and 8A, block 802 of FIG. 8A may follow block 756 of FIG. 7B.

In block 802 (“Assign A Weight Value To Each Travel Attribute”), a weight value 316 may be assigned to each travel attribute associated with a potential place to visit 302 with coordinates 314. For example, the travel attribute module 238 of FIG. 2 may be used to assign a weight value 316 to each travel attribute. The travel attributes and weight values 316 may correspond to the travel attributes 320 and weight values 316 of FIG. 3. Block 802 may be followed by block 804.

In block 804 (“Sum All Weighted Travel Attributes For Each Potential Place To Visit”), all weighted travel attributes 320 may be summed together for each potential place to visit 302 with coordinates 314. For example, the travel attribute module 238 of FIG. 2 may be used to sum together all weighted travel attributes 320 for each potential place to visit 302 with coordinates 314. Block 804 may be followed by block 806.

In block 806 (“Generate A Travel Attribute Score For Each Potential Place To Visit”), a travel attribute score for each potential place to visit 302 with coordinates 314 may be generated. For example, the travel attribute module 238 of FIG. 2 may be used to generate the travel attribute scores. The travel attribute scores may correspond to the travel attribute scores 322 of FIG. 3. The travel attribute scores may include the sum of all of the weighted travel attributes 320 for each potential place to visit 302 with coordinates 314. More particularly, the travel attribute score 322 for each potential place to visit 302 with coordinates 314 may include the sum of all the weighted travel attributes 320 for that potential place to visit 302 with coordinates 314. Block 806 may be followed by block 808.

In block 808 (“Combine The Content Attribute Score With The Travel Attribute Score To Generate A Combined Attribute Score For Each Potential place to visit”), the travel attribute score 322 and content attribute score 318 for each potential place to visit 302 with coordinates 314 may be combined together to generate a combined attribute score 324 for each potential place to visit 302 with coordinates 314. For example, the travel attribute module 238 of FIG. 2 may be used to generate the combined attribute scores 324. The content attribute scores 318, travel attribute scores 322, and combined attribute scores 324 may correspond to the content attribute scores 318, travel attribute scores 322, and combined attribute scores 324 of FIG. 3. Block 808 may be followed by block 810.

In block 810 (“Prioritize The Potential Places To Visit Based On Their Respective Combined Attribute Scores”), the potential places to visit 302, each with a combined attribute score 324, may be prioritized with respect to each other based on their respective combined attribute scores 324. For example, the travel attribute module 238 of FIG. 2 may be used to prioritize the potential places to visit 302, each with a combined attribute score 324, with respect to each other based on their respective combined attribute scores 324.

FIG. 8B shows an example flow diagram of a method 850 to classify the content sources of FIG. 5 based on their content source scores 328, arranged in accordance with at least one implementation described herein. The method 850 may be implemented, in whole or in part, by one or more of the traveler devices 104 or travel server 106 of FIG. 1, the system 200 of FIG. 2, or another suitable device, server, and/or system. The method 850 may begin at block 852. Alternatively, or in addition thereto, and as indicated by a circular block “F” in each of FIGS. 6B and 8B, block 852 of FIG. 8B may follow block 656 of FIG. 6B.

In block 852 (“Identify The Content Source For Each Potential Place To Visit With Coordinates”), the content source where each potential place to visit 302 with coordinates 314 was located may be identified. For example, the content source ranking module 240 of FIG. 2 may be used to identify the content source in which each potential place to visit 302 with coordinates 314 was located. Block 852 may be followed by block 854.

In block 854 (“Tag Each Potential Place To Visit With Coordinates With A Content Source Identifier”), a content source identifier that identifies the content source where each potential place to visit 302 with coordinates 314 was located may be tagged to each potential place to visit 302 with coordinates 314. For example, the content source ranking module 240 of FIG. 2 may be used to tag the content source identifiers to their respective potential place to visit 302. Alternatively, or in addition thereto, the content source analysis module 232 of FIG. 2 may be used to tag the content source identifiers to their respective potential place to visit 302. The content source identifiers may correspond to the content source identifiers 326 of FIG. 3. Block 854 may be followed by block 856.

In block 856 (“Sum All Combined Attribute Scores For Each Potential Place To Visit Having The Same Content Source Identifier To Generate A Content Source Score”), all of the combined attribute scores 324 for each potential place to visit 302 that has the same content source identifier 326 may be summed together to generate a content source score for each content source 404. For example, the content source ranking module 240 of FIG. 2 may be used to sum all of the combined attribute scores 324 for each potential place to visit 302 together to generate a content source score for each content source 404. The combined attribute scores 324, content source identifiers, and content source scores may correspond to the combined attribute scores 324, content source identifiers 326, and content source scores 328 of FIG. 3. Block 856 may be followed by block 858.

In block 858 (“Prioritize The Content Sources Based On Their Respective Content Source Scores”), each content source with a content source score 328 may be prioritized with respect to each other based on their respective content source scores 328. For example, the content source ranking module 240 of FIG. 2 may be used to prioritize each content source with a content source score 328 with respect to each other based on their respective content source scores 328.

The implementations described herein may include the use of a special purpose or general-purpose computer including various computer hardware or software modules, as discussed in greater detail below.

Embodiments within the scope of the technology disclosed herein may also include computer-readable media for carrying or having computer-executable instructions or data structures stored thereon. Such computer-readable media may be any available media that may be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium which may be used to carry or store desired program code means in the form of computer-executable instructions or data structures and which may be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above may also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although implementations of the present inventions have been described in detail, it will be understood that the various changes, substitutions, and alterations could be made hereto without departing from the spirit and scope of the invention.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” will be interpreted as “including but not limited to,” the term “having” will be interpreted as “having at least,” the term “includes” will be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases will not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” will be interpreted to mean “at least one” or “one or more”); the same holds true for the use of definite articles used to introduce claim recitations. In addition, even if a specific number of an introduced claim recitation is explicitly recited, those skilled in the art will recognize that such recitation will be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, will be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” and the like include the number recited and refer to ranges which may be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The present disclosure is not to be limited in terms of the particular embodiments described herein, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds, compositions, or biological systems, which may, of course, vary. It is also to be understood that the terminology used herein is for the purpose of describing particular embodiments only, and is not intended to be limiting. Accordingly, the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method to build a personalized content-based travel plan, the method comprising:
receiving input effective to indicate at least one content source to analyze for potential places to visit;
accessing the at least one content source to analyze for potential places to visit from a non-transitory computer medium;
at a processor, analyzing the at least one content source for one or more potential places to visit;
identifying at least one content attribute for each of the one or more potential places to visit and tagging the at least one content attribute to the one or more potential places to visit;
determining whether each of the one or more potential places to visit has a physical location with coordinates and tagging the one or more potential places to visit with its respective coordinates; and
for each of the one or more potential places to visit with coordinates:
assigning a weight value to each of the at least one content attributes that is tagged to the one or more potential places to visit with coordinates;
summing up all of the least one content attributes with weight values for each of the one or more potential places to visit with coordinates to generate a content attribute score;
prioritizing the one or more potential places to visit with respect to each other based on their respective content attribute scores; and
at an output device, providing a prioritized list of the one or more potential places to visit with coordinates to a user.

2. The method according to claim 1, further comprising identifying at least one travel attribute for each of the one or more potential places to visit with coordinates and tagging the at least one travel attribute to the one or more potential places to visit with coordinates; and
for each of the one or more potential places to visit with coordinates:
assigning a weight value to each of the at least one travel attributes that is tagged to the one or more potential places to visit with coordinates;
summing up all of the at least one travel attributes with weight values for each of the one or more potential places to visit with coordinates to generate a travel attribute score;
combining the content attribute score with the travel attribute score to generate a combined attribute score for each of the one or more potential places to visit with coordinates; and
prioritizing the one or more potential places to visit with respect to each other based on their respective combined attribute scores.

3. The method according to claim 2, wherein analyzing the at least one content source for one or more potential places to visit with the processor comprises processing the at least one content source with named-entity recognition processing techniques at the processor in order to locate and classify the one or more potential places to visit within the at least one content source.

4. The method according to claim 3, further comprising:
receiving selection data indicative of at least one of the one or more potential places to visit with coordinates chosen by the user; and
in response to receiving the selection data, displaying the at least one of the one or more potential places to visit with coordinates chosen by the user on a map at the output device.

5. The method according to claim 4, further comprising:
receiving visit order data indicative of the desired order for visiting each of the one or more potential places to visit with coordinates chosen by the user; and
in response to receiving the visit order data, displaying one or more transportation options between each of the one or more potential places to visit with coordinates chosen by the user on the map at the output device.

6. The method according to claim 5, further comprising:
receiving transportation selection data indicative of the desired transportation options chosen by the user between each of the one or more potential places to visit with coordinates; and
in response to receiving the transportation selection data, creating a travel plan itinerary including a list of the one or more potential places to visit with coordinates chosen by the user arranged according to the desired order for visiting each of the one or more potential places to visit with the desired transportation options chosen by the user between each of the one or more potential places to visit with coordinates.

7. The method according to claim 2, further comprising displaying at least one of the one or more potential places to visit on a map at the output device concurrent with the prioritized list of the one or more potential places to visit with coordinates.

8. The method according to claim 2, further comprising:
for each of the one or more potential places to visit with coordinates:
tagging each of the one or more potential places to visit with coordinates with a content source identifier, wherein the content source identifier identifies the at least one content source in which the one or more potential places to visit was located;
summing up all of the combined attribute scores for each of the one or more potential places to visit with coordinates having the same content source identifier in order to generate a content source score for each of the at least one content sources;
prioritizing each of the at least one content sources based on their respective content source scores; and
providing a prioritized list of the at least one content sources to the user.

9. The method according to claim 8, further comprising:
receiving content source selection data indicative of at least one content source chosen by the user from the prioritized list of the at least one content sources; and
in response to receiving the content source selection data, providing the prioritized list of the one or more potential places to visit with coordinates for the at least one content source chosen by the user at the output device.

10. A computer-implemented system to build a personalized content-based travel plan, the system comprising:
an input module configured to receive input effective to indicate at least one content source to analyze for potential places to visit;
a content source analysis module configured to:
access the at least one content source to analyze for potential places to visit from a non-transitory computer medium;
analyze the at least one content source for one or more potential places to visit;
identify at least one content attribute for each of the one or more potential places to visit; and
tag the at least one content attribute to the one or more potential places to visit;
a coordinate module configured to:
access coordinates from at least one coordinate database;
determine whether each of the one or more potential places to visit has a physical location with coordinates; and
tag the one or more potential places to visit with its respective coordinates;
a content attribute module, wherein for each of the one or more potential places to visit with coordinates the content attribute module is configured to:
assign a weight value to each of the at least one content attributes that is tagged to the one or more potential places to visit with coordinates;
sum up all of the least one content attributes with weight values for each of the one or more potential places to visit with coordinates to generate a content attribute score; and
prioritize the one or more potential places to visit with respect to each other based on their respective content attribute scores; and
an output device communicatively coupled to a processor device and configured to provide a prioritized list of the one or more potential places to visit with coordinates to a user.

11. The system according to claim 10, further comprising
a travel attribute module configured to:
access travel attributes from at least one travel attribute database;
identify at least one travel attribute for each of the one or more potential places to visit with coordinates;
tag the at least one travel attribute to the one or more potential places to visit with coordinates;
assign a weight value to each of the at least one travel attributes that is tagged to the one or more potential places to visit with coordinates;
sum up all of the at least one travel attributes with weight values for each of the one or more potential places to visit with coordinates to generate a travel attribute score;
combine the content attribute score with the travel attribute score to generate a combined attribute score for each of the one or more potential places to visit with coordinates; and
prioritize the one or more potential places to visit with respect to each other based on their respective combined attribute scores.

12. The system according to claim 11, wherein the content source analysis module is communicatively coupled to the processor device and is configured to process the at least one content source with named-entity recognition processing techniques in order to locate and classify the one or more potential places to visit within the at least one content source.

13. The system according to claim 12, wherein the input module is configured to receive selection data indicative of at least one of the one or more potential places to visit with coordinates chosen by the user and the output device is configured to display the at least one of the one or more potential places to visit with coordinates chosen by the user on a map at the output device in response to receiving the selection data.

14. The system according to claim 13, wherein the input module is configured to receive visit order data indicative of the desired order for visiting each of the one or more potential places to visit with coordinates chosen by the user and the output device is configured to display one or more transportation options between each of the one or more potential places to visit with coordinates chosen by the user on the map at the output device in response to receiving the visit order data.

15. The system according to claim 14, further comprising:
a transportation option module configured to:
access transportation options from at least one transportation option database;
identify one or more transportation options between potential places to visit; and
provide the one or more transportation options to the output device for display on the map, wherein the input module is configured to receive transportation selection data indicative of the desired transportation options chosen by the user between each of the one or more potential places to visit with coordinates; and
an itinerary module configured to create a travel plan itinerary including a list of the one or more potential places to visit with coordinates chosen by the user, arranged according to the desired order for visiting each of the one or more potential places to visit, and including the desired transportation options chosen by the user between each of the one or more potential places to visit with coordinates.

16. The system according to claim 10, wherein the output device is configured to display at least one of the one or more potential places to visit on a map at the output device concurrent with the prioritized list of the one or more potential places to visit with coordinates.

17. The system according to claim 10, further comprising a content source ranking module, wherein, for each of the one or more potential places to visit with coordinates, the content source ranking module is configured to:
tag each of the one or more potential places to visit with coordinates with a content source identifier, wherein the content source identifier identifies the at least one content source in which the one or more potential places to visit was located;
sum up all of the combined attribute scores for each of the one or more potential places to visit with coordinates having the same content source identifier in order to generate a content source score for each of the at least one content sources;
prioritize each of the at least one content sources based on their respective content source scores; and
provide a prioritized list of the at least one content sources to the output device to display the prioritized list of the at least one content sources to the user.

18. The system according to claim 17, wherein the input module is configured to receive content source selection data indicative of at least one content source chosen by the user from the prioritized list of the at least one content sources and the output device is configured to display the prioritized list of the one or more potential places to visit with coordinates for the at least one content source chosen by the user in response to receiving the content source selection data.

19. A computer program product to build a personalized content-based travel plan, the computer program product comprising:
a non-transitory storage medium; and
computer program code, encoded on the non-transitory storage medium, wherein the computer program code is executable by at least one processor to perform or control performance of operations comprising:
receiving input effective to indicate at least one content source to analyze for potential places to visit;
analyzing the at least one content source for one or more potential places to visit;
identifying at least one content attribute for each of the one or more potential places to visit and tagging the at least one content attribute to the one or more potential places to visit;
determining whether each of the one or more potential places to visit has a physical location with coordinates and tagging the one or more potential places to visit with its respective coordinates; and
for each of the one or more potential places to visit with coordinates:
assigning a weight value to each of the at least one content attributes that is tagged to the one or more potential places to visit with coordinates;
summing up all of the least one content attributes with weight values for each of the one or more potential places to visit with coordinates to generate a content attribute score;
prioritizing the one or more potential places to visit with respect to each other based on their respective content attribute scores; and
providing a prioritized list of the one or more potential places to visit with coordinates to a user.

20. The computer program product of claim 19, wherein the operations further comprise:
identifying at least one travel attribute for each of the one or more potential places to visit with coordinates and tagging the at least one travel attribute to the one or more potential places to visit with coordinates; and
for each of the one or more potential places to visit with coordinates:
assigning a weight value to each of the at least one travel attributes that is tagged to the one or more potential places to visit with coordinates;
summing up all of the at least one travel attributes with weight values for each of the one or more potential places to visit with coordinates to generate a travel attribute score;
combining the content attribute score with the travel attribute score to generate a combined attribute score for each of the one or more potential places to visit with coordinates; and
prioritizing the one or more potential places to visit with respect to each other based on their respective combined attribute scores.
